(19) United States
(12) Patent Application Publication
(10) Pub. No.: US 2026/0211247 A1
(43) Pub. Date: Jul. 23, 2026

(54) ADJUSTABLE HELMET DISPLAY SYSTEM

(71) Applicant: GoPro, Inc., San Mateo, CA (US)

(72) Inventors: Alfred Boyadgis, Haymarket (AU); Sebastian Bernard Alexander Adams, Sydney (AU); Lei Liang, Sydney (AU)

(21) Appl. No.: 19/035,690

(22) Filed: Jan. 23, 2025

(51) Int. Cl. G02B 27/01

(52) U.S. Cl. CPC G02B 27/0176; G02B 27/0172; G02B 2207/101

(57) ABSTRACT

A helmet with a face shield. The face shield includes a screen and adjustment mechanisms. The screen is flexible. The adjustment mechanisms are configured to move the screen toward or away from an eye or eyes of a user to change a focal length of the screen relative the eyes of the user.

### TECHNICAL FIELD

A display system that provides images within a helmet and specifically a display that is adjustable so that the display may be focused to accommodate user visual needs.

### BACKGROUND

Helmets provide protection to motorcycle riders (e.g., users), pilots, and race car drivers. Helmet users may not have direct access to navigational and traffic aids as easily as automotive drivers may have through infotainment systems. Helmets may include a limited display to provide limited information to the helmet user.

### SUMMARY

The present teachings provide a helmet with a face shield. The face shield includes a screen and adjustment mechanisms. The screen is flexible. The adjustment mechanisms are configured to move the screen toward or away from an eye of a user to change a focal length of the screen relative the eyes of the user.

The present teachings provide a helmet with a shell, a face shield, and a screen. The face shield is movably connected to the shell. The screen is located adjacent to the face shield. The adjustment mechanisms are in communication with the screen so that the screen is movable relative to the shell.

The present teachings provide a helmet with a shell, an electronic module, and adjustment mechanisms. The shell includes an eyeport. The electronic module is located within the shell adjacent to the eyeport. The adjustment mechanisms have adjustment components located adjacent to opposing ends of the electronic module so that the opposing ends of the electronic module are movable independently and relative to the shell using the adjustment components.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is an isometric view of a motorcycle helmet;

FIG. 1B is a schematic view of the motorcycle helmet of FIG. 1A;

FIG. 2 is an exploded view of the motorcycle helmet of FIGS. 1A-1B;

FIG. 3A is a rear schematic view of a face shield of a helmet including an electronic module with an adjustable display;

FIG. 3B is a top schematic view of the face shield and an adjustment system; and

FIG. 3C is an exploded view of the adjustable display.

FIG. 3D is a plan view of a connection of a lens of the adjustable display of FIG. 3C.

FIG. 4A is a front view of an adjustable display in a flat position.

FIG. 4B is a side view of the adjustable display of FIG. 4A along line IVB-IVB in a flat position.

FIG. 4C is a front view of the adjustable display in a flexed position.

FIG. 4D is a side view of the adjustable display of FIG. 4C along line IVD-IVD.

### DETAILED DESCRIPTION

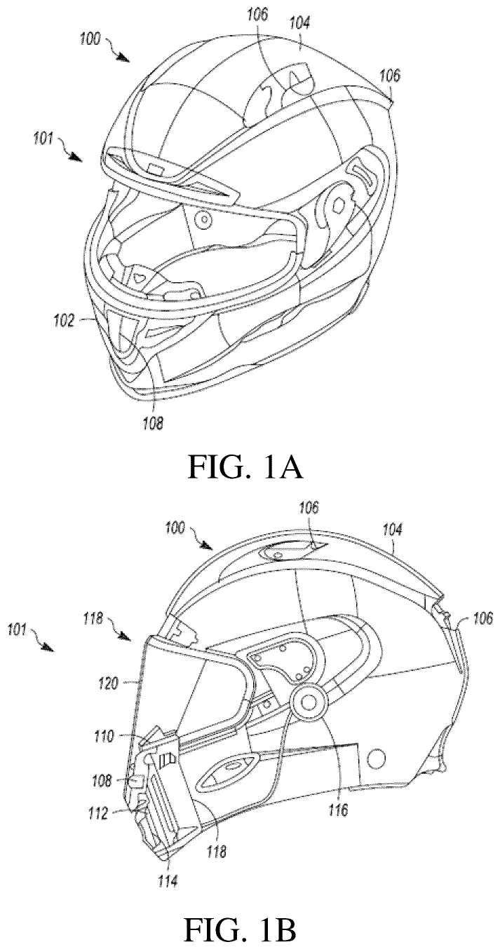

FIG. 1A is an isometric view of a helmet 100 including a visual communication system 101 embedded in the frontal portion of the helmet 102. FIG. 1B is a side schematic view of the helmet 100 and the visual communication system 101 of FIG. 1A.

The helmet 100 has an impact absorbing shell 104, various air vents 106, and a forward mounted camera 108. The impact absorbing shell 104 may be made of composite fiber, carbon fiber, graphite, graphene, or a combination thereof. The air vents 106 allow air to flow into the helmet for cooling such as by air moving into the helmet 100 through the air vents 106 as is experienced during high-speed or downhill motion events. The air vents 106 may be selectively openable depending on the amount of ventilation required. The helmet 100 also comprises an internal lining for comfort purposes.

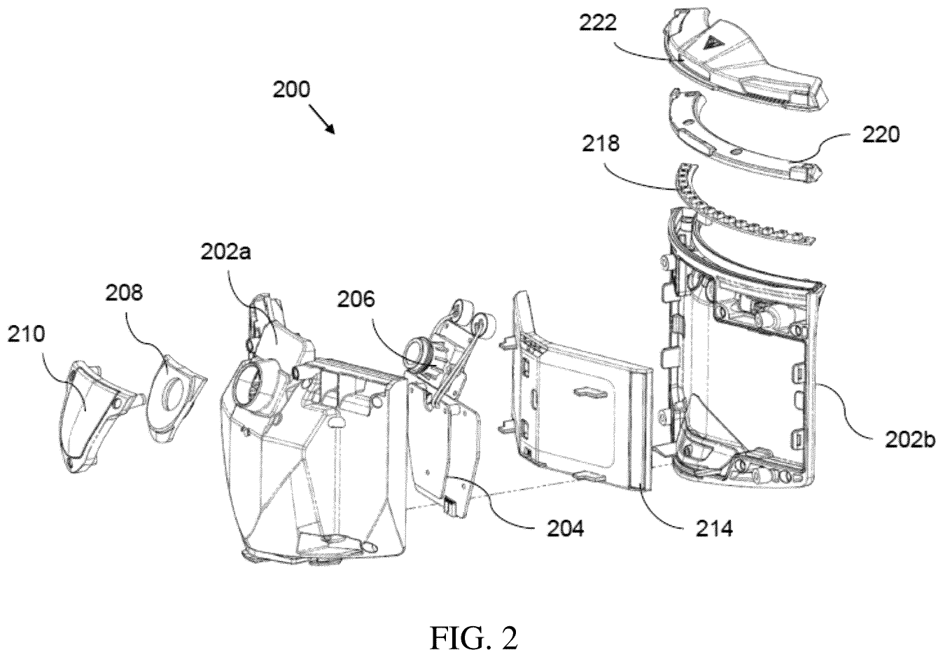

The visual communication system 101 comprises an array or groupings of light emitting devices 110 that emit light in the visible spectrum, that is, light which is visible to the user of the helmet 100. The system also comprises a camera control board 112 and a main electronic board (e.g., the main electronic board 204 shown in FIG. 2) that includes a data communication interface 114. The visual communication system 101 may be connected to integrated speakers and/or drivers 116 that can be used to provide audio aids or riding/driving cues to the user of the helmet 100.

The riding/driving cues are provided to the user in a peripheral field of view so that the user can see the riding/driving cues while focusing a point of view on the road ahead of the user. This allows for a fast reaction to the everchanging riding/driving environment in all riding/driving circumstances. The point of view is a direction in which the user is looking and the field of view is the outside world available to the user of the helmet 100. If the user is directing eyes towards the road, the visual communication system 101 is effective in the user's peripheral vision, that is, the peripheral field of view. Therefore, the user does not have to move gaze or point of view to notice the riding/drive cues in the form of light cues.

On full-face helmets, the viewing region is called the eyeport 118. The eyeport 118 may be covered by a face shield 120. The light array 110 or another light source may be positioned so as not to obstruct the eyeport 118. The eyeport 118 may include one or more lenses or displays that a user may see while wearing the helmet 100.

The data communication interface 114 may include a near net communication system such as a Bluetooth module, WIFI module, ZigBee, or a combination thereof arranged to be paired with a mobile communication device. The data communication interface 114 may be arranged to receive situational related data from one or more sources, including from sensors external to the helmet 100. A processing module is configured to analyze the situational related data and using the light array 110, generate light cues or light signals that provide driving or riding guidance to the user of the helmet 100. The visual communication system 101 may also include a memory arranged to store riding/driving and/or navigational data.

Situational data may be related to the vehicle, e.g., a motorcycle, the rider, and/or the surrounding environment. For example, situational related data could be speed of the vehicle, lean angle, weather data, GPS data, or information incoming from a network, such as the internet.

FIG. 2 is an exploded view of a visual communication module 200 similar to the helmet 100 of FIGS. 1A-1B. The visual communication module 200 comprises a housing that houses the main electronic board 204 and the camera module 206. The housing includes of a front panel 202a and a rear panel 202b that can be releasably fastened together. A gasket 208 may be mounted to the front of the housing to prevent water from entering the visual communication module 200 or the helmet (e.g., the helmet 100). The gasket 208 may be made of or include rubber, an elastomer, silicone a flexible material, a semi-rigid material, a rigid material, or a combination thereof. The visual communication module 200 includes the camera module 206 that includes a lens protector 210 that completes an optical path of the camera module 206.

The visual communication module 200 also comprises a battery located in a battery housing 214 and an integrated battery control system. An array of light emitting devices, in this case a multi-color LED array 218, may be positioned along an inner-upper edge of a chin bar of the helmet (e.g., the helmet 100), delivering informational alerts via the projection of light to the user. The LED array 218 supports a full spectrum of color and is paired with a waveguide 220 inside the helmet and a waveguide cover 222 in a manner such that light emitted by the light emitting devices of the LED array 218 is visible to the user.

The data communication interface (e.g., the data communication interface 114) is arranged on the main electronic board 204 which also comprises the processing unit and the memory, the Wi-Fi unit, the Bluetooth module, the LED array control unit, and a gyroscopic unit. The main electronic board 204 is shown adjacent to the camera module 206 but may be positioned elsewhere within the visual communication module 200, such as between the battery housing 214 and the rear housing 202b.

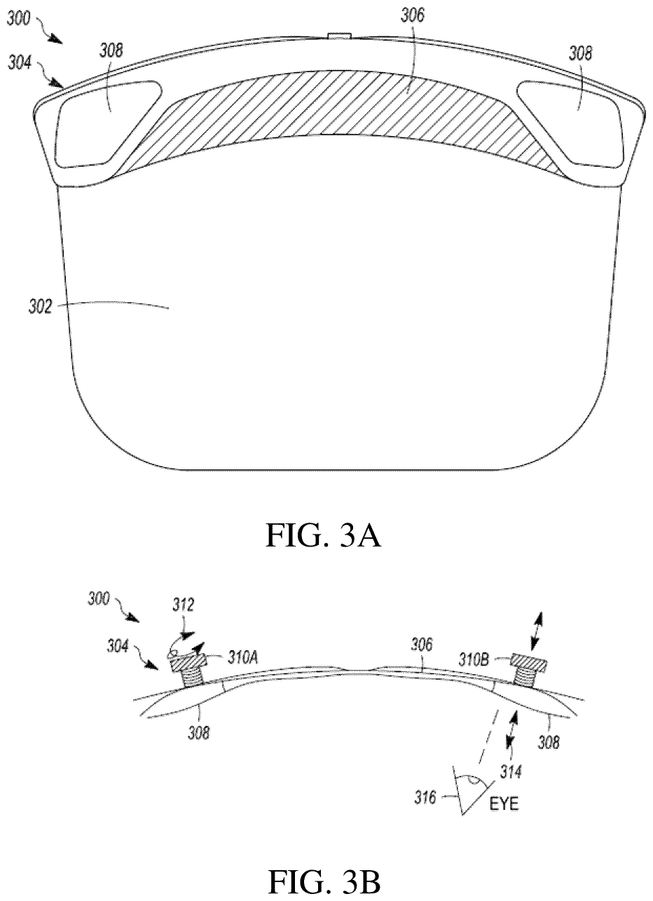

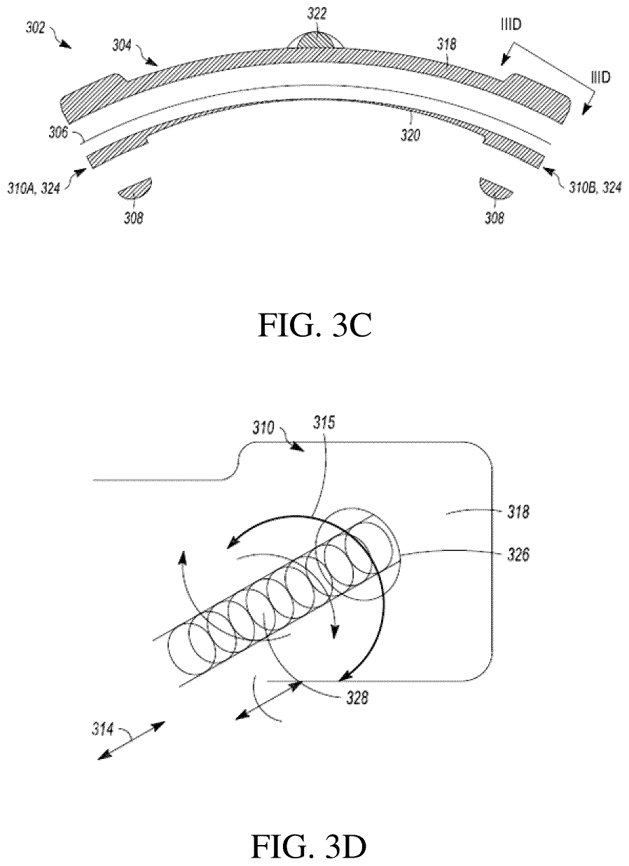

FIG. 3A is a rear schematic view of a face shield 300 that is configured to cover a face of a user of a helmet (e.g., the helmet 100). The face shield 300 includes a shield 302 that protect a user's face and allows the user to see while wearing a helmet. The shield 302 may block debris and other things from contacting the user's face. The face shield 300 includes an electronic module 304.

The electronic module 304 may include one or more screens (or displays) 306. The electronic module 304 may project images, display images, provide information, provide directions, provide feedback, or a combination thereof to the user of the face shield 300. The electronic module 304 may be located across a top of the face shield 300. The electronic module 304 may span from a first end of the face shield 300 to a second end of the face shield 300. The electronic module 304 may extend along a longitudinal axis that extends from the first end to the second end. The electronic module 304 may follow a shape of the face shield 300. The electronic module 304 may extend along a top of the face shield 300, such as above the user's point of view. The electronic module 304 may be located out of a direct field of view of a user, such as in the user's peripheral view. The electronic module 304 may include one or more screens 306 and one or more lenses 308.

The screen 306 shown as part of the face shield 300 extends between a first end and a second end of the face shield 300. The screen 306 may display information to the user as discussed herein. The screen 306 may be flexible. A curvature of the screen 306 may be changed so that images and/or information displayed on the screen 306 may be tuned/focused for or by each individual user. The screen 306 may a liquid crystal display (LCD), an organic light-emitting diode (OLED), or both. The screen 306 may be any type of material so that the screen 306 is flexible and the screen may display the information discussed herein. The screen 306 may not directly display anything. The screen 306 may not be directly visible by a user. The screen 306 may provide light, signals, or both to the lenses 308 and the lenses 308 may display the information to the user. Thus, the screen 306 may be indirectly visible to the user. The screen 306 may be located adjacent to the one or more lenses 308.

The one or more lenses 308, e.g., the lenses 308, may direct light to a location of interest, away from the screen 306, or both. The lenses 308 may direct light, narrow a beam of light, direct light to a predetermined location, or a combination thereof. The lenses 308 may increase light, magnify an image, magnify a symbol, magnify the display, or a combination there of. The lenses 308 may increase a size of an image and/or symbol on a screen by a factor of about 2:1 or more, 3:1 or more, 4:1 or more, 5:1 or more, 6:1 or more, or even 7:1 or more. The lenses 308 may increase a size by about 20:1 or less, 15:1 or less, 12:1 or less, or about 10:1 or less. For example, if the image has a size that is about 1 (e.g., 1 cm) then the image may appear to be about 3 (e.g., 3 cm) if the factor is 3:1. The lenses 308 may be located at the first end and the second end of the face shield 300. The screen 306 may be located between the lenses 308. The screen 306 may be visible only at a location of the lenses 308, between the lenses 308, or at both the lenses 308 and between the lenses 308. The screen 306 may be visible at other locations (e.g., along a center) but may not be focused at the locations other than at the side.

The lenses 308 may be complementary in shape with a portion of the display. The lenses 308 may have a shape that is round, square, rectangular, oval, domed, flat, geometric, nongeometric, or a combination thereof. The lenses 308 may be coplanar to one another in the non-focused state. The lenses 308 may move with the display so 306 as the display is focused so that the displays are no longer coplanar. The lenses 308 may be collimating lenses, may collimate light, or both. The lenses 308 may enlarge an image, direct light towards an eye, clarify an image, or a combination thereof. The lenses 308 may be a Fresnel lens, a diffractive optical lens, a meta surface lens, or a combination thereof. The lenses 308 may direct light from the screen 306, around the screen 306, or both. The lenses 308 may be adjusted so that information on the screen 306 may be focused in a predetermined direction associated with the user. The lenses 308 may be moved to vary an optical length (e.g., a distance between an eye of a user and the lenses 308, the lenses 308 and the screen 306, or both) so that the items to be displayed to the user may be clear and/or in focus for the user. The lenses 308 may physically display the information from the screen 306. The screen 306 may be covered so that information may not be visible by viewing the screen 306, but the screen 306 may be visible through the lenses 308. A single screen 306 may generate images that are displayed through the lenses 308.

FIG. 3B is a top schematic view of the face shield 300 of FIG. 3A. The face shield 300 includes the electronic module 304 and the screen 306 in the center and the lenses 308 on opposing sides of the screen 306. A first lens 308 is located adjacent to a first adjustment mechanism 310A and a second lens 308 is in communication with a second adjustment mechanism 310B so that each of the lenses 308 are separately movable in a direction 312, a direction 314, or both, when a user manipulates the first and second adjustment mechanisms 310A, 310B.

The first and second adjustment mechanisms 310A, 310B (e.g., the adjustment mechanisms 310 (inclusive of 310A and 310B)) move the lenses 308 individually. The adjustment mechanisms 310 may be or include rotary to linear movement devices, rachets, twisting devices, detents, screws, pivots, hand knobs, threaded wing nuts, or a combination thereof. The hand knobs may include grips, projections, an X shape, a T shape, an I shape, or a combination thereof. The adjustment mechanisms 310 may move the lenses relative to the shield 302, the screen 306, or both. The adjustment mechanism 310 may move the lenses 308 towards and away from an eye 316 of a user in the direction 314, that is, a direction of translation. The adjustment mechanisms 310 may vary the distance between the lenses 308 and the eye 316 of the user. The adjustment mechanisms 310 may adjust the lens 308 to be aimed at the eye 316 of the user. The adjustment mechanism 310 may axially move as shown by the direction 314 or may twist or rotationally move as shown by the direction 312. The adjustment mechanisms 310 may have a static piece, a movable piece, or a combination thereof of the screen 306, the lenses 308, or both. The adjustment mechanisms 310 may move the lenses 308 relative to the screen 306 so that the information of the screen 306 is focused for each user.

The adjustment mechanisms 310 permit movement of each of the lenses 308. Each lens 308 may be adjusted for each eye 316 so that if eyes of the user have different vision needs, each eye may be separately accommodated. Furthermore, the screen 306, the lenses 308, or both may be twisted (e.g., rotated up or down) so that the lenses 308 may be focused for each eye 316, angled towards each eye 316, angled downwards towards each eye 316, or a combination thereof. The adjustment mechanisms 310 may only move the lenses 308 relative to the screen 306 to focus the screen 306.

FIG. 3C illustrates an exploded view of the shield 302 including the electronic module 304. The electronic module 304 includes the screen 306 that extends between lenses 308 that are located at the first end and the second end of the shield 302. The shield 302 includes an outer frame 318.

The outer frame 318 may be rigid, substantially rigid, or have some flexibility. The outer frame 318 may be substantially rigid so that the adjustment mechanisms 310 may move the lenses 308 relative to the outer frame 318. The outer frame 318 may provide some structure for the lenses 308 to move relative to the screen 306 so that an inner frame 320 of the housing moves the lenses 308. The outer frame 318 may be more rigid than the inner frame 320. The inner frame 320 may be moved relative to the outer frame 318. The outer frame 318 may be a shell of the helmet or connected to the shell of the helmet. The outer frame 318 may be made of or include metal, plastic, a polymer, acrylic, poly carbonate, polyethylene, polypropylene, polymethyl methacrylate, polyethylene terephthalate, polyvinyl chloride, acrylonitrile-butadiene styrene, fiberglass, carbon fiber, Kevlar, epoxy, aramid fiber, or a combination thereof.

The inner frame 320 may be less rigid than the outer frame 318 so that the inner frame 320 may be flexed relative to the outer frame 318. The inner frame 320 may be made of a same material as the outer frame 318. The inner frame 320 may be thinner than the outer frame 318 so that the inner frame 320 is less rigid than the outer frame 318. The inner frame 320 may be made of or include a softer material than the outer frame 318. The inner frame may be at least partially transparent or include transparent regions. The inner frame 320 may be fixed in a center location and movable at outer edges. The inner frame 320 may be fixed at an anchor point 322 and movable at movement locations 324.

The outer frame 318, the screen 306, and the inner frame 320 may be connected at the anchor point 322. The outer frame 318, the screen 306, and the inner frame 320 may be fixed at the anchor point 322 so that the inner frame 320 is prevented from moving at the anchor point 322. The anchor point 322 may be located at a center of the screen 306. The anchor point 322 may be located an equal distance from each of the movement locations 324. The anchor point 322 may be a location where the screen 306, the inner frame 320, or both are fixed to the outer frame 318. The anchor point 322 may be a physical connection. The anchor point 322 may restrict motion of the inner frame 320 relative to the outer frame 318. The anchor point 322 may be a weld, a screw, a rivet, an adhesive, a fixed connection, a melted material, a nail, a bond, a fastener, a chemical bond, or a combination thereof. The anchor point 322 may be located between two movement locations 324.

The movement locations 324 may be portions of the screen 306, the inner frame 320, or both that are movable relative to one another. The movement locations 324 may be at ends of the shield 302, ends of the screen 306, adjacent to the lenses 308, by the adjustment mechanisms 310, part of the adjustment mechanisms 310, or a combination thereof. The movement locations 324 may pivot, move linearly, rotate, twist, or a combination thereof. The movement locations 324 may be configured to move the lenses 308 so that a focus of the screen 306 is varied. The movement locations 324 may move the inner frame 320 so that the inner frame 320 linearly moves, flexes, rotates, or a combination thereof. The movement locations 324 may move relative to a user.

FIG. 3D illustrates a close-up view of the adjustment mechanism 310 of FIG. 3C along lines IIID-IIID. The first adjustment mechanism 310A is identical to the second adjustment mechanism 310B of FIG. 3C. The adjustment mechanism 310 includes a joint 326 that is in communication with the outer frame 318.

The joint 326 permits rotational movement, linear movement, or both. The joint 326 may be a ball joint, a pivot joint, a joint that slides, or a combination thereof. The joint 326 may allow for movement of the screen 306, lens 308 or both of FIG. 3C into the outer frame 318, away from the outer frame 318, up, down, left, right, forward, backwards, or a combination thereof. The joint 326 may allow for movement in the direction 314 (e.g., lateral movement), movement in the direction 315 (e.g., rotational movement), or both. The joint 326 may fixedly connect the inner frame 320, the screen 306, or both to the outer frame 318. The joint 326 may permit the inner frame 320, the screen 306, or both to move relative to the outer frame 318. The joint 326 may include one or more fasteners 328.

The fasteners 328 may assist in adjusting the inner frame 320 relative to the outer frame 318 to focus the lenses 308 and individualize each lens 308 for each user. The fasteners 328 may be loosened so that the inner frame 320, the screen 306, or both may move and then be tightened so that once focused, the lenses 308 remain in place with respect to the user. The fasteners 328 may use friction to retain a location of the lenses 308. The fasteners 328 may push the inner frame 320 away from the outer frame 318. The fasteners 328 may rotate the inner frame 320, the screen 306, or both. The fasteners 328 may permit movement in the direction 314, the direction 315, or both. The fasteners 328 may be threaded, detented, ratcheted, movable, adjustable, or a combination thereof. The fasteners 328 may be or include a screw, a nut and screw, a lead screw, a ball screw, or a combination thereof.

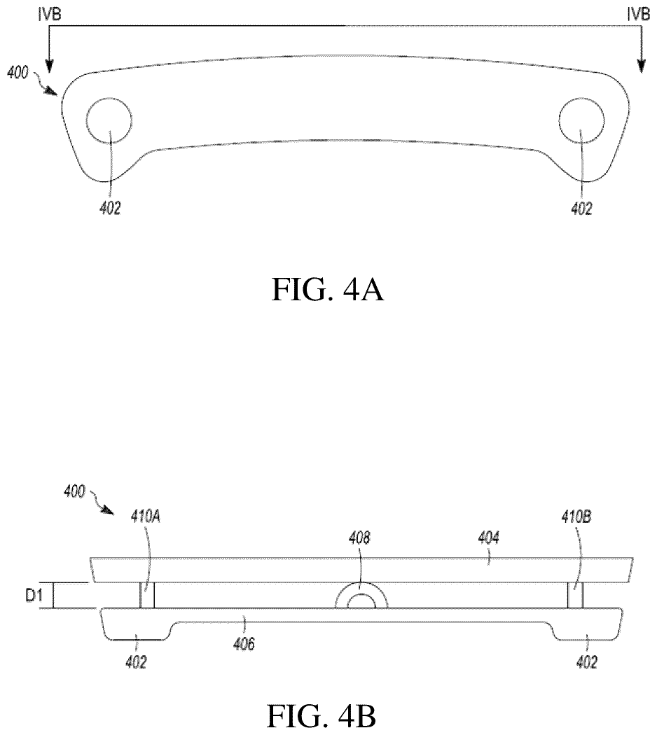

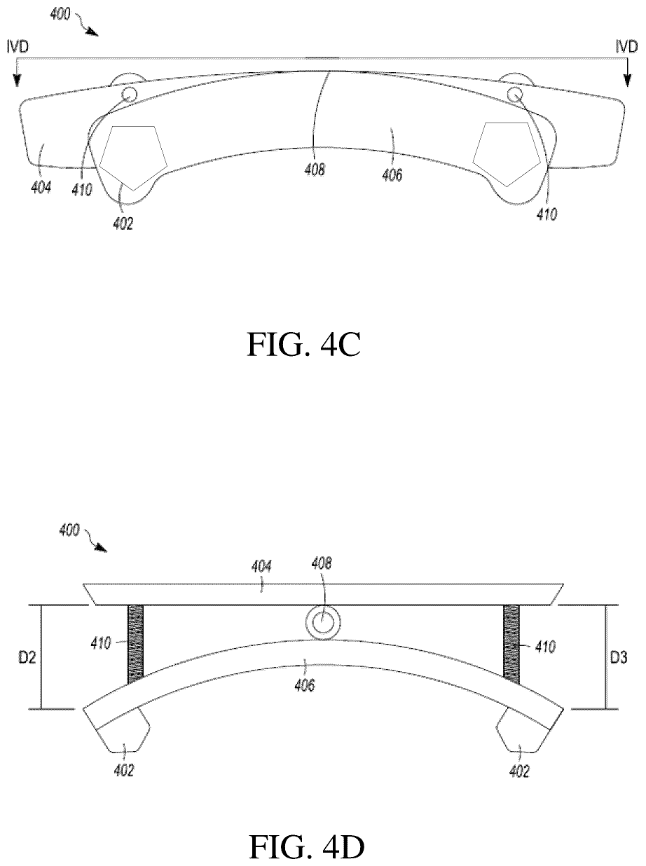

FIG. 4A illustrates a front view of an electronic module 400 including lenses 402 on opposing sides. As shown, the lenses 402 have a circular shape. FIG. 4B is a top view of the electronic module 400 of FIG. 4A when viewed along lines IVB-IVB. The electronic module 400 includes an outer frame 404 and an inner frame 406. The outer frame 404 is located a distance (D1) from the inner frame 406. The distance D1 shows the inner frame 406 is in an unbiased position (e.g., at rest or position one) so that the lenses 402 are coplanar. Portions of the inner frame 406 are movable relative to the outer frame 404. The inner frame 406 and the outer frame 404 are connected at an anchor point 408.

The anchor point 408 prevents the center of the inner frame 406 from moving relative to the outer frame 404. The anchor point 408 fixedly connects the outer frame 404 and the inner frame 406 so that the inner frame 406 is not movable at the anchor point 408. The inner frame 406 may be moved on one or both sides of the anchor point 408 by one or more adjustment mechanisms 410 (e.g., a first adjustment mechanism 410A and a second adjustment mechanism 410B), two of which are shown in FIG. 4B. The adjustment mechanisms 410 may move the inner frame 406 relative to the outer frame 404.

FIG. 4C is a front view of the electronic module 400 of FIGS. 4A and 4B in a biased state (e.g., flexed or position two). The electronic module 400 includes the outer frame 404 spaced apart from the inner frame 406 that includes the lenses 402 on opposing ends. The anchor point 408 is located in a center of the outer frame 404 and the inner frame 406 so that the center of the inner frame 406 is fixed relative to the center of the outer frame 404.

The adjustment mechanisms 410 are located on opposing ends of the inner frame 406. The anchor point 408 is located between the adjustment mechanisms 410. The adjustment mechanisms 410 individually move the inner frame 406 and the lenses 402 relative to the outer frame 404 so that the lenses 402 may be focused independently for each individual user. Thus, as shown, the lenses 402 are each moved by the adjustment mechanisms 410 to bias the lenses 402 and focus the lenses 402 for each individual user.

FIG. 4D is a top view of the electronic module 400 of FIG. 4C along line IVD-IVD. The electronic module 400 includes an outer frame 404 and an inner frame 406. The anchor point 408 is located between the outer frame 404 and the inner frame 406 so that the inner frame 406 at the anchor point 408 does not move relative to the outer frame 404.

Each end of the electronic module 400 includes an adjustment mechanism 410 and lens 402. One of the adjustment mechanisms 410 moves the first end of the inner frame 406 including one of the lenses 402 a second distance D2. A second end of the inner frame 406 includes another of the adjustment mechanisms 410 that moves the second end of the inner frame 406 including a second of the lenses 402 a third distance D3. The distance D2 may differ from the distance D3. Thus, the first end including the first lens 402 and the second end including the second lens 402 of the inner frame 406 may be moved different distances D2, D3 so that a user may individually adjust the ends of the inner frame 406 to accommodate for different vision needs of each eye, individual, or both.

The adjustment mechanisms 310 and 410 of FIGS. 3A-3D and FIGS. 4A-4D are substantially identical and operate in similar manners. The adjustment mechanisms 310 and 410 permit individuals to move the outer frames (318, 404) and inner frames (320, 406) relative to one another.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A helmet, comprising:
a face shield, comprising:
a screen that is flexible; and
adjustment mechanisms that are configured to move the screen toward or away from an eye of a user of the helmet to change a focal length of the screen relative the eye of the user.

2. The helmet of claim 1, wherein the adjustment mechanisms are connected to the face shield so that as the adjustment mechanisms move, the screen moves.

3. The helmet of claim 2, wherein the adjustment mechanisms are threaded members that rotate about axes, and wherein the screen moves along the axes to change the focal length of the screen.

4. The helmet of claim 2, wherein the adjustment mechanisms are hand knobs that are rotatable from an outside of the helmet.

5. The helmet of claim 1, wherein the face shield further comprises:
an outer frame; and
an inner frame that is in communication with the screen,
wherein the inner frame and the screen are movable relative to the outer frame by the adjustment mechanisms.

6. The helmet of claim 1, wherein the adjustment mechanisms are further configured to rotate the screen about a longitudinal axis of the screen.

7. The helmet of claim 1, further comprising:
an anchor point that prevents a portion of the screen from being moved by the adjustment mechanisms.

8. A helmet, comprising:
a shell;
a face shield movably connected to the shell;
a screen located adjacent to the face shield; and
adjustment mechanisms in communication with the screen so that the screen is movable relative to the shell.

9. The helmet of claim 8, wherein a portion of the screen overlaps the shell and a portion of the screen overlaps the face shield.

10. The helmet of claim 8, wherein the screen is part of an electronic module and the electronic module comprises:
an outer frame located on a first side of the screen;
an inner frame on a second side of the screen; and
lenses located at ends of the inner frame that are movable with the inner frame when the inner frame is moved by the adjustment mechanisms.

11. The helmet of claim 10, wherein the adjustment mechanisms each comprise:
a joint that allows for linear movement and rotational movement.

12. The helmet of claim 11, wherein the joint is a ball joint that is directly connected the outer frame to permit movement of the inner frame relative to the outer frame.

13. The helmet of claim 8, wherein the adjustment mechanisms comprise fasteners that assist in moving the adjustment mechanisms, fixing the adjustment mechanisms, or both.

14. The helmet of claim 8, further comprising:
a first lens located at a first end of the screen; and
a second lens located at a second end of the screen,
wherein the adjustment mechanisms are configured to independently move the first end and the second end of the screen.

15. A helmet, comprising:
a shell including an eyeport;
an electronic module located within the shell adjacent to the eyeport; and
adjustment mechanisms having adjustment components located adjacent to opposing ends of the electronic module so that the opposing ends of the electronic module are movable independently and relative to the shell using the adjustment components.

16. The helmet of claim 15, wherein the adjustment components comprise:
a joint that allows the electronic module to pivot, rotate, twist, or a combination thereof.

17. The helmet of claim 16, wherein the joint is a ball joint.

18. The helmet of claim 15, wherein the adjustment components comprise:
fasteners that move the opposing ends of the electronic module and lock the opposing ends in place once the electronic module is moved to a desired position.

19. The helmet of claim 15, wherein the electronic module comprises:
an outer frame;
an inner frame that is movable by the adjustment mechanisms; and
a screen located between the inner frame and the outer frame.

20. The helmet of claim 19, further comprising:
lenses located at the opposing ends of the electronic module, wherein the screen is visible through the lenses.
